(19) United States
(12) Patent Application Publication
(10) Pub. No.: US 2011/0316298 A1
(43) Pub. Date: Dec. 29, 2011

(54) Energy efficient banner towing system & method

(76) Inventor: Kenrick Rampersad, Brentwood, NY (US)

(21) Appl. No.: 13/134,843

(22) Filed: Jun. 17, 2011

Related U.S. Application Data
(60) Provisional application No. 61/397,952, filed on Jun. 18, 2010.
(60) Provisional application No. 61/399,918, filed on Jul. 21, 2010.
(60) Provisional application No. 61/461,585, filed on Jan. 20, 2011.
(60) Provisional application No. 61/463,818, filed on Feb. 23, 2011.

(51) Int. Cl. B60R 13/00; B60L 1/00

(52) U.S. Cl. 296/21; 307/10.1

(57) ABSTRACT

A moving vehicle based energy-efficient banner system includes a moving vehicle and a banner structure associated with the moving vehicle configured for securing and maintaining attention of responders in a vicinity of the moving vehicle and banner structure and for deriving electrical and mechanical energy to facilitate said securing and maintaining by capturing natural wind and sunlight, or airflow or water flow available by movement of the moving vehicle. The banner structure includes a controller, a water-driven or wind-driven turbine for generating electrical current, an electrical current storage device and a display device connected to the controller for displaying visual content for delivery to responders.

### RELATED APPLICATIONS

This application claims priority under 35 U.S.C.§ 119(e) from U.S. Provisional Patent Application No. 61/397,952, filed Jun. 18, 2010, U.S. Provisional Patent Application No. 61/399,918, filed Jul. 21, 2010, U.S. Provisional Patent Application No. 61/461,585, filed Jan. 20, 2011 and U.S. Provisional Patent Application No. 61/463,818, filed Feb. 23, 2011, which applications are incorporated by reference herein.

### BACKGROUND OF THE INVENTION

The invention relates broadly to advertising by banner towing and, more particularly relates to a banner towing system in which a wind or water-driven electrical generator is included in a towed visual display for both powering visual displays and audio sound effects on the flexible, electrically conductive towed banner.

Banners comprise an advertising medium supported by a temporary framework attached externally to an aircraft, motorized boat or moving land vehicle and towed behind the respective aircraft, boat or vehicle. While banners, or banner advertising media may simply comprise a cloth upon which advertising content is printed or drawn, same may also comprise devices for illumination, or for generating some other type of communication to attract viewers, for example, sound generating devices. Such devices require electrical power to drive them commensurate with strength of the resultant light, sound or other signal they might communicate.

Various banner towing systems are known. For example, U.S. Pat. No. 2,095,350 to Soule describes an aircraft-towed lighted banner. The Soule banner includes light bulbs which are electrically powered through a power cable connected to a conventional power source operational within the airplane towing the banner. Depending on the number or lights and their respective power requirements, the cost to power same can be quite high. For that matter, the cost for the conduits in both capital equipment cost and cost to maintain weight of the aerial towline comprising same.

Published WIPO patent application 2007/0220790 A1 to Wagter describes an illuminated animated flag flying in the wind upon a stationary flagpole. The illuminated flag is powered by a base generator, which supplies electric power to metal oxide fibers embedded in the flag (i.e. flexible conductive visual/audio display “sheet”). Wagter's illuminated flag, however, operates based on power supplied by a wind-driven electrical generator (FIG. 9), so is at the mercy of the wind, therefore. That is, in the absence of wind for powering the electrical generator, Wagter '790 requires an auxiliary source of power to drive, i.e., illuminate and animate the flag.

For that matter, Wagter further discloses a handheld flag including a movement responsive generator to illuminate the hand held flag. The generator relies on air movement facilitated by user's vigorous movement of the hand held flag, i.e., by the user' flag waving movements. Hence, like the flagpole mounted illuminated animated flag where there is no wind, the hand-held flag does not operate as intended in an absence of flag waving movement without an auxiliary source.

U.S. Pat. No. 6,830,357 of Lopez describes a wind turbine in the roof of a motor vehicle to generate power to illuminate a system of Christmas wreath lights. As the battery power required to energize the system of Christmas wreath lights would overwhelm the automobile's battery and charging system, an auxiliary wind based power system (FIG. 6). The FIG. 6 wind system, however, being in the body of the towing vehicle, adds extra weight which is undesirable.

US patent application publication number 2005/126878 A1 to Armstrong describes a motor vehicle towing a banner with rudimentary animation. The banner is on a flagpole which is “towed” in a sense as it is mounted on the vehicle itself. The “flag” portion of the banner is compelled to move vertically up and down the flagpole by the moving automobile or truck and by a force of the wind create by vehicle forward movement intersecting with the banner.

US patent application publication number 2010/02828906 A1 to Dohi, et al., describes a flying ultra light aircraft (ultra light) plane which has visually perceptible show elements. The ultra-light decorated airplane resembles a character, such as a flying dinosaur. The ultra light also is able to pull a banner that simulates a flying character. There is no use of wind power in either the ultra light or the banner that generates electrical power for any purpose.

U.S. Pat. No. 6,967,450 to Durlach describes the use of moving parts to augment the display of a banner, as well as the use of loudspeakers to produce sound in coordination with his visibly movable displays.

US patent application publication number 2008/0313937 A1 to Boyce discloses an animated airborne banner which is carried by a balloon or parasail. The banner includes a wireless access device and an on-board computer including a GPS interface to produce the images, and to display and modify the images depending upon the instant detected location. The banner may be controlled by a remote computer based upon land, which communicates wirelessly by radio or other wireless energy with the airborne banner.

US patent application publication number 2010/0122479 A1 to Golle describes an aircraft-towed animated banner system wherein the banner connects to the aircraft with a tether and wherein the aircraft includes an onboard power source for powering the banner's display, which is illuminated for viewing both day and night. The generator has a fuel requirement separate from and in addition to that of the aircraft.

U.S. Pat. No. 7,341,351 B2 to Halmi et al describes a radio controlled animated balloon with advertising indicia projected onto the inside transparent or translucent balloon, with projectors and a power supply. The power supply requires a fuel source.

U.S. Pat. No. 7,784,206A to Trainer describes a manually pushed animated media display having a unitary wheel for moving the banner. A person riding a Segway personal vehicle pushes the banner. For that matter, the user can remotely control advertising media displayed upon a user operated media display. The media display requires a fuel source.

U.S. Pat. No. 6,972,689 B1 to Morgan, et al., describes a portable signed towed by a vehicle, where the animation display is powered by a conventional power source or solar array.

U.S. Pat. No. 7,816,797 B2 of Nair describes a method for harvesting energy from ocean waves to generate electricity in general. In Nair, wave motion within a body of water supporting a floatable device causes changes in the strain of a magnetorestrictive element in the vicinity of an electrically conductive coil or circuit, thereby generating and electrical current which may be captured for instant use or for storage. Additionally, U.S. Pat. No. 7,695,242 of Fuller describes a bladeless turbine, where having plurality of substantially parallel disks being held in spaced-apart relation by a plurality of peripheral spacers having an airfoil shape, wherein each of the peripheral spacers is continuously curved. In Fuller '242, the bladeless turbine has an inlet for directing fluid towards the disks and an outlet for directing fluid away from the disks, wherein further the disks are connected by a shaft, and further wherein each disk has a central opening, wherein the array of central openings of the disks together make a path for fluid to exit the turbine.

### SUMMARY OF THE INVENTION

The present invention overcomes the shortcomings of the prior art banner towing systems and devices. The following text refers to a banner which is towed or otherwise affixed to a moving vehicle such as an airplane, a land vehicle or a floating boat or amphibious airplane/boat. By “banner” the term is meant to comprise any kind of flexible or rigid display, with or without a peripheral structural frame, screen, monitor, projector screen, sign, poster, marker, signboard, flag, placard, streamer, pennant or bunting, whether lightweight or weighted, and capable of portraying electronically generated, mechanically generated, and/or stationary visual images and/or audio sounds.

In an embodiment, the invention provides an audio and visually animated banner towed by an aircraft or land vehicle, where the banner, or towed banner vehicle comprises a wind driven electrical generator. For example, the low flying airplane can tow a banner over New York State's Jones Beach State Park with audio sounds and visual displays, without the need for a conventional power source. In another embodiment, the invention provides an audio and visually animated banner maintained on a float or other water vehicle that is towed by a boat or other watercraft, and includes a water-driven electrical generator. Alternatively, a bladeless turbine such as described in U.S. Pat. No. 7,695,242 of Fuller can be used in association with the banner, since a bladeless turbine is virtually silent and completely enclosed, which avoids many of the drawbacks of bladed turbines such as noise, radar interference, visual pollution and wildlife injuries, all of which would interfere with the audio sound transmissions associated with the visual display of the present invention. As a further alternate embodiment, on less windy days/nights a Dyson type air multiplier can be used, which uses a little of the towing vehicle's generator output, multiplying the air many times (for example, 16 times) and then through the bladeless turbine of Fuller '242, and/or through a Venturi generator and/or through conventional rotors, then overflowing or giving back the higher amps, current, charge and/or voltage back to the vehicle's battery and/or some of the power to the banner to power the visual and/or audio content. The vehicle can be standing still or in motion. The Dyson type air multiplier therefore uses less current and puts out more air than from one or more other generators.

The present invention produces power to the banner being towed with the regenerative power source, preferably driving a visually animated and sound producing display made up of an array of flexible embedded metal oxide fibers in the banner (i.e. in a flexible conductive visual/audio display “sheet”). On land, an example could be a golf cart or small ATV or mini-compact utility vehicle pulling a banner, which emits a picture of the mascot “MR. MET®” of the New York METS® baseball team organization singing the copyrighted sounds of the song “Meet the Mets” or “Take Me Out to the Ball Game” or the like, where the forward velocity of the land vehicle powers the visual animation and audio sound of the display on the banner being towed by the land vehicle, without the need for a conventional power source.

In the water, a floating vessel such as a boat, can tow a banner where the visual animation and audio sound is powered by a Pelamis wave generated power source associated with the floating vessel. The towed banner and signs of the present invention include a sound portion, e.g., audio, noise, sound, speakers, microphone etc. and a visual portion, e.g., visual animations, images/DVD/videos, etc., combined in a single source. The banner may comprise a land vehicle and an air vehicle, for example, in a case where of a flag-like animated and illuminated banner raised above a towed banner vehicle that may be towed by an electric car during a game in a stadium or on track of the Indy 500 car racing event, or even behind a boat in water along a seashore. Half or part of the invention with sounds and visual animations, images, etc can be provided on the flying banner and the other half on the towed land vehicle.

In an embodiment, the invention embodies a moving vehicle based energy-efficient banner system includes a moving vehicle and a banner structure associated with the moving vehicle configured for securing and maintaining attention of responders in a vicinity of the moving vehicle and banner structure and for deriving electrical and mechanical energy to facilitate said securing and maintaining by capturing natural wind and sunlight, or airflow or water flow available by movement of the moving vehicle. The banner structure includes a controller, a water-driven or wind-driven turbine for generating electrical current, an electrical current storage device and a display device connected to the controller for displaying visual content for delivery to responders.

In another embodiment, the invention includes a moving vehicle based energy-efficient banner system, comprising a moving vehicle and a banner structure associated with the moving vehicle configured for securing and maintaining attention of responders in a vicinity of the moving vehicle and banner structure and for deriving electrical and mechanical energy to facilitate said securing and maintaining by capturing natural wind and sunlight, or airflow or water flow available by movement of the moving vehicle.

The banner structure comprises a controller, an electrical current storage device and a high voltage projection image system disposed within a retractable extendable support arm for displaying visual content for delivery to responders.

In another embodiment, the invention includes a method for displaying a series of discrete advertising displays to viewing responders at a plurality of viewing locations using a moving vehicle. The method comprises steps of a) utilizing forward-thrust driven electrical generators and the forward movement of the moving vehicle to create an electrical power supply, b) receiving and memory-storing audio and visual advertising content for public responder viewing, a database for receiving and storing data c) delivering the stored audio and visual content to said viewing responders using any of an electrical visual display device and electrical audio delivery device and both, wherein said devices are electrically powered by the electrical power supply and d) controlling said display remotely.

### BRIEF DESCRIPTION OF THE DRAWINGS

Aspects of the invention will become apparent upon reading the following detailed description and upon reference to the accompanying drawings in which, like references may indicate similar elements:

FIG. 1 is a side elevation view of a ground vehicle towed banner of the present invention, where the banner is contained within a frame attached to a trailer of a tractor trailer truck;

FIG. 2 is a detail view of an alternate embodiment for a Pelamis type generator attached in a collection of Pelamis type generators attached in an array around a frame of a banner, where banner wave motion powers each generator to power audio sound and visual images upon the banner;

FIG. 2A is a side elevation view of a banner having the array of Pelamis type generators arrayed around the frame of a banner, with optional ball joint generators where the pivoting of a ball joint moves and the movement thereof generates electricity, where the ball joints move by wind power or wave power;

FIG. 3 is a side elevation view of an airplane towed banner of the present invention;

FIG. 4 is a close-up side elevation view of an air movement powered generator activated by towing;

FIG. 5 is a close-up side elevation view of an alternate embodiment for an air movement powered generator activated by towing, with a Tesla Coil providing a corona generated visual image;

FIG. 6 is a side elevation view of a water-towed banner and FIG. 6A is a diagrammatic rear view showing a pair of floating pontoons below the banner and banner frame;

FIG. 7 is a side elevation view of an amphibious airplane/boat with air and water movement powered generators, solar generators and surface wind contact generators towing a banner with audio sound and visual displays;

FIG. 8 is a side elevation view of an alternate embodiment for a water wave generated generator and other generators upon an amphibious airplane/boat towing a banner with audio sound and visual displays;

FIG. 9 depicts side elevation views of an alternate embodiment for a towed banner with mechanical or generator powered image or sound enhancement techniques;

FIG. 10 is a top plan view thereof showing a plurality of remote projectors in a fully deployed position and stabilized by folding braces;

FIG. 11 is a top plan view thereof showing a single remote projectors in a fully deployed position and stabilized by folding braces;

FIGS. 12A, 12B and 12C are top plan views of enlargement features for the projectors of FIGS. 10 and 11;

FIG. 12D is a perspective view showing an enlarged projected image upon the towed banner shown in FIGS. 12A, 12B or 12C of the present invention with audio sound and visual imagery;

FIG. 12E shows a perspective view of an alternate embodiment where instead of the images projected upon a banner 172 in FIGS. 9-12D, the underside of an airplane wing can also comprise the banner associated with the projectors.

FIG. 13 is a perspective view of an alternate embodiment for a wind driven music box mechanically producing an audio sound associated with the banner;

FIG. 14 is a side elevation view of a towed banner of the present invention strengthened by interleaved slats to provide rigidity during the towing process;

FIG. 15 is a side elevation view of an alternate embodiment for a wind driven flute box mechanically producing an wind driven sounds associated with the banner;

FIG. 16 is a side elevation view of a mechanical gong accessory mechanically producing audio sounds associated with the towed banner;

FIG. 17 is a perspective view of a stringed wind driven harp assembly mechanically producing audio sounds associated with the towed banner;

FIG. 18A is a side elevation view of an alternate embodiment for a airplane towing the banner;

FIG. 18B depicts the inner workings of the airplane of as equipped with acoustic sound reducing insulation features;

FIG. 19 is a side elevation view of an alternate embodiment for a airplane towing the banner, where the airplane is equipped with further acoustic sound reducing insulation features;

FIG. 20, FIG. 21, FIG. 22 and FIG. 23 are close-up detail views of the sound reducing features as in the airplanes of FIG. 18A and 19;

FIG. 24 is a schematic diagram depicting an embodiment of a processor/server that may be used to control the operation of the banner and related devices;

FIG. 25 is a system level diagram depicting communication between the processor/server and the banner and related devices; and

FIG. 26 is schematic depiction of a signal-bearing storage media in a form of a magnetic data storage diskette for storing instructions for execution by a processor to implement a method of controlling the banner and related devices.

### DETAILED DESCRIPTION OF THE INVENTION

The following is a detailed description of example embodiments of the disclosed technology depicted in the accompanying drawings. The example embodiments are in such detail as to clearly communicate the disclosed technology. However, the amount of detail offered is not intended to limit the anticipated variations of embodiments. On the contrary, the intention is to cover all modifications, equivalents, and alternatives falling within the spirit and scope of the invention, as defined by the appended claims. The descriptions below are designed to make such embodiments obvious to a person of ordinary skill in the art.

As described above, the invention provides an audio and visually animated banner towed by an aircraft, land vehicle or watercraft, where the banner, or towed banner vehicle comprises a wind-driven or water-driven electrical generator.

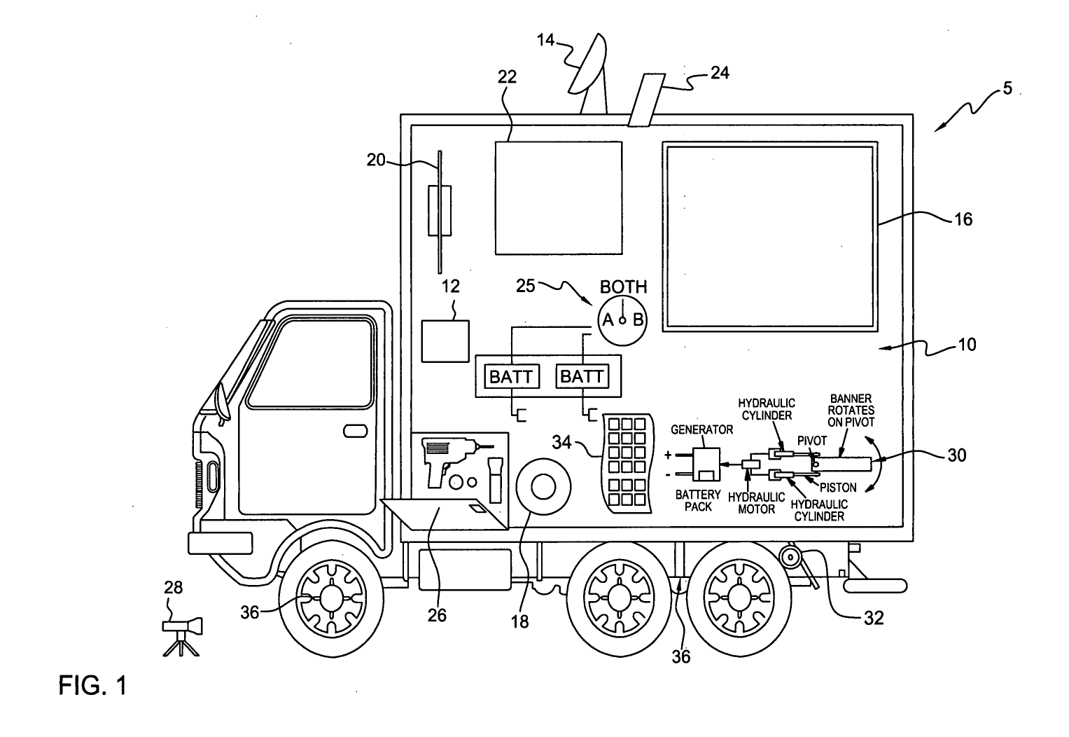

In a FIG. 1 embodiment, the invention comprises a truck 5 (banner-delivery vehicle) comprising a banner-like construction 10 used as a stage for delivery of banner data. As used herein, banner data is meant to be interpreted to be any data for communication to a user in vicinity of the banner delivery vehicle. Truck 5/banner-like construction 10 is configured with a computer 12 for controlling animated sign components, which may receive in real time in a live data stream via a satellite dish 14, or previously stored on DVDs or other computer readable media). Video parts of the animated sign components are projected by a flat screen TV/monitor 16, where audio pars are projected by a speaker and audio system 18. Various renewable energy sources for driving the computer 12, flat screen TV/monitor 16 and other systems and devices found in the truck 5/banner-like construction 10.

For example, a wind driven turbine 20, such as, preferably, for example, a Venturi effect wind turbine or other wind turbine, such as a Servino wind turbine with an accelerating rotor within the Venturi wind turbine to multiply wind speed exponentially, is used to generates alternating current (AC), which may be utilized as it is generated as well as converted to direct current (DC) and stored in a battery (not shown in FIG. 1). A solar cell 22 is used to generate DC for instant use and storage. The AC or DC may be used to drive the Flat screen TV/monitor 16, a GPS locator 24 provides GPS data by which animation may be coordinated, and AC & DC power tools and flashlights (see locking power compartment 26 with invertors supplying ac & dc power for tools and flashlight, and flashlight with adjustable tripod stand 28). Alternative secondary fuel sources include a hydraulic motor wind driven generator 30, a roller driven generator 32, an electronic fabric current generator 34, a current generating shock absorber 36, and a thermal current generator powered from brakes, or a ball joint generator. The various power sources can be alternately controlled by “A/B/B” switches 25 known to those skilled in the art and can alternately replace power from dead conventional vehicle batteries with power provided by the various generators associated with the banner.

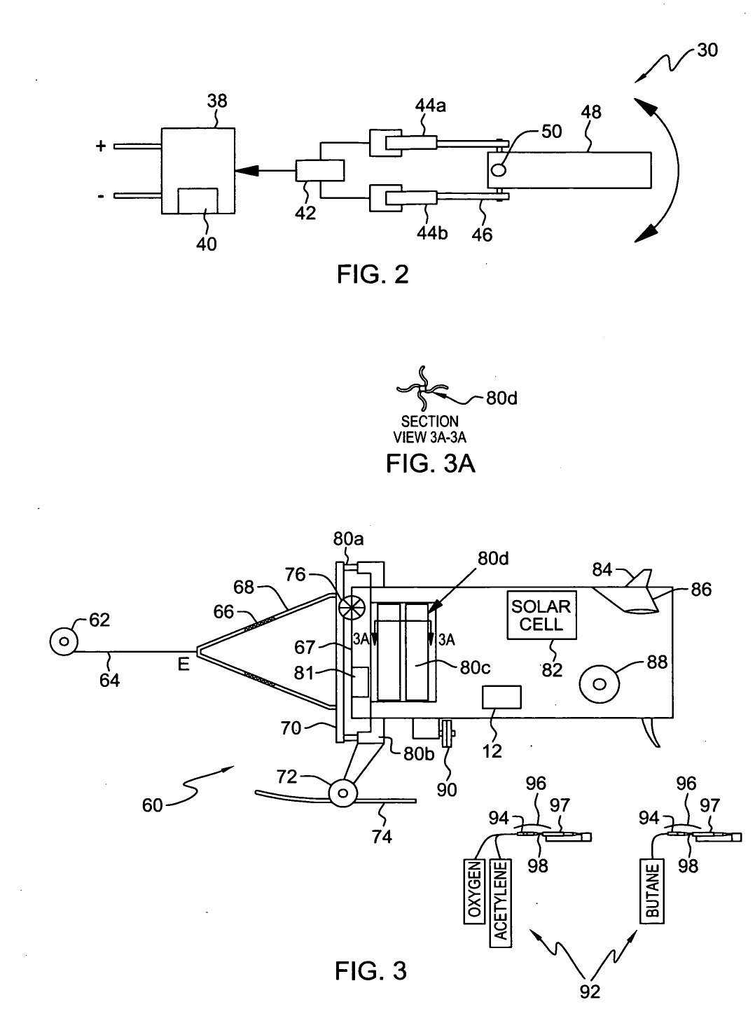

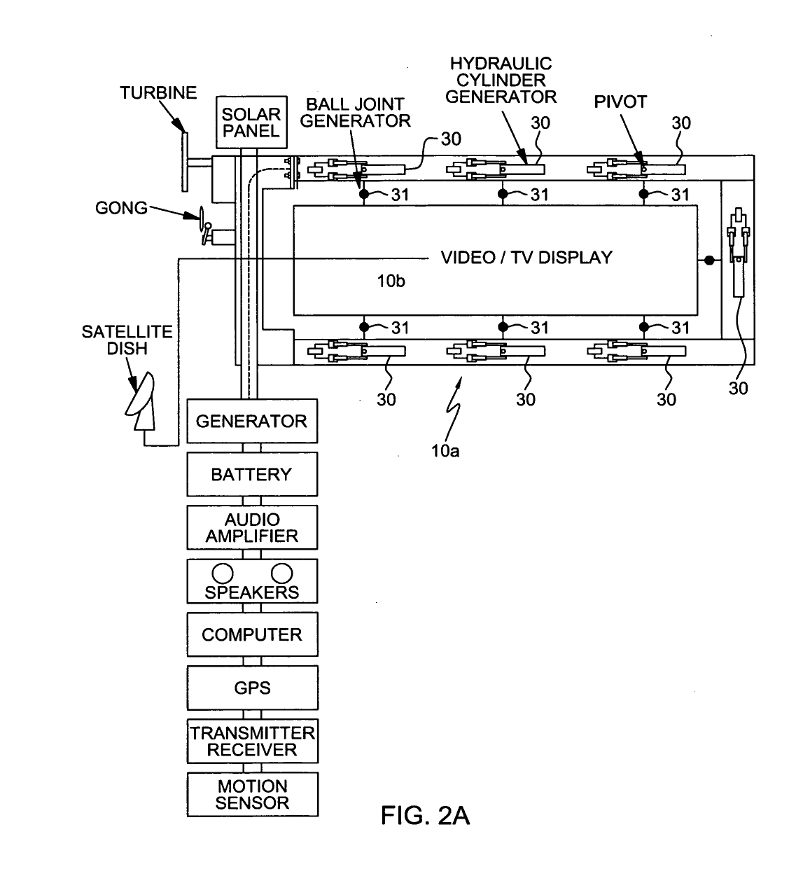

FIG. 2 depicts hydraulic motor wind driven generator 30, such as a Pelamis type generator, for example, in more detail. The hydraulic motor driven generator 30 further includes a generator 38, a batter pack 40, a hydraulic motor 42, hydraulic cylinders 44a and 44b, a piston 46, a banner 48 that rotates on pivot 50 and another hydraulic cylinder 52. The flag motion drives hydraulic cylinders 44a and 44b powering hydraulic motor 42 which powers the generator 30 to activate animated electrical devices on banner construction 10.

FIG. 2A is a side elevation view of a banner 10a having the array of generators, such as, but not limited to Pelamis type generators 30, arrayed around the frame of a banner 10a with display surface 10b, with optional ball joint generators 31 where the pivoting of a ball joint therein moves and the movement thereof generates electricity, where the ball joints move by wind power or wave power, with or without association with other generators shown in FIG. 1. Furthermore, the weight of the banner imposes further gravity-based forces on the ball joint generator 31.

FIG. 3 depicts a towed banner construction 60. Towed banner construction 60 is attached to a motor vehicle, such as truck 5 (FIG. 1) at a spool for reeling line 62. The spool for reeling line 62 includes an adjustable retractable cable and adjustably connects to a spring loaded shock absorbing towing bridle 64. The spring loaded shock absorbing towing bridle 64 includes a towing bridle 66 connected to a frame 70 that rolls on wheel 72. The frame 70 includes an aerodynamic edge 67 and supports aerodynamic banner with landing gear of floats 74. The construction 60 further comprises prism sun catchers 76 for spreading light to catch viewer's attention. Shock absorbers 80a and 80b cooperate with vertical turbines to generate current to drive a generator 80c to the power banner and store DC in battery pack 81. A solar cell 82 also generates DC.

A rudder 84 and a horizontal stabilizer 86 support operation, where a remote controlled video screen 88 (and/or amplified receiver and speakers) deliver content. The banner 74 is aerodynamically designed. Generated AC or battery-powered metallic disks 90 grind together to make sparks. The mechanism also may be wind powered to generate the sparks solely from captured mechanical energy. Lighters 92 have piezo-electric ignition 94, a wind guard 96 and a spring loaded track fed burning metal 97 that generate flames 98.

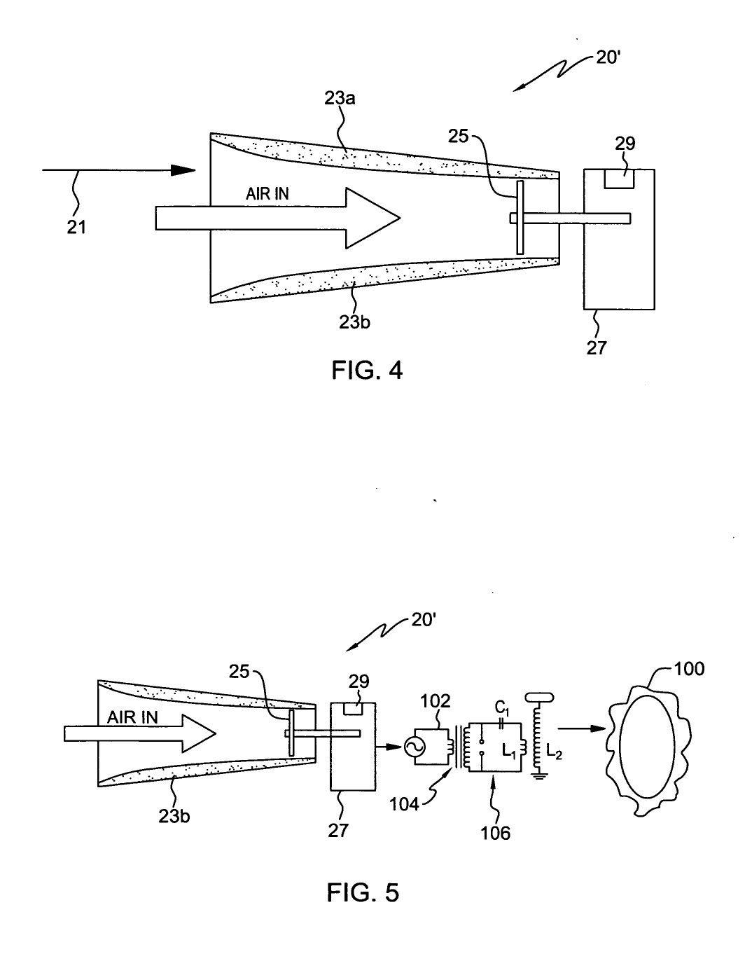

FIG. 4 depicts a turbine generator (20′) that may be used in the inventive embodiment. The turbine generator (20′) comprises a deflected wind surface 21, a venturi 23A with a tapered duct 23B, a turbine 25, the actual generator 27 and a battery pack 29.

FIG. 5 depicts a use of the turbine generator 20′ to generate high voltage to drive a corona generated from tesla coil 100. That is, the turbine generator 20′ drives and AC mains which drives a high voltage transformer 104 to create a spark gap 106. The spark gap is across a circuit comprising a high voltage capacitor C, and a primary coil L1. The primary coil L1 drives a secondary coil L2 and torus 106 to generate the appropriate voltage level.

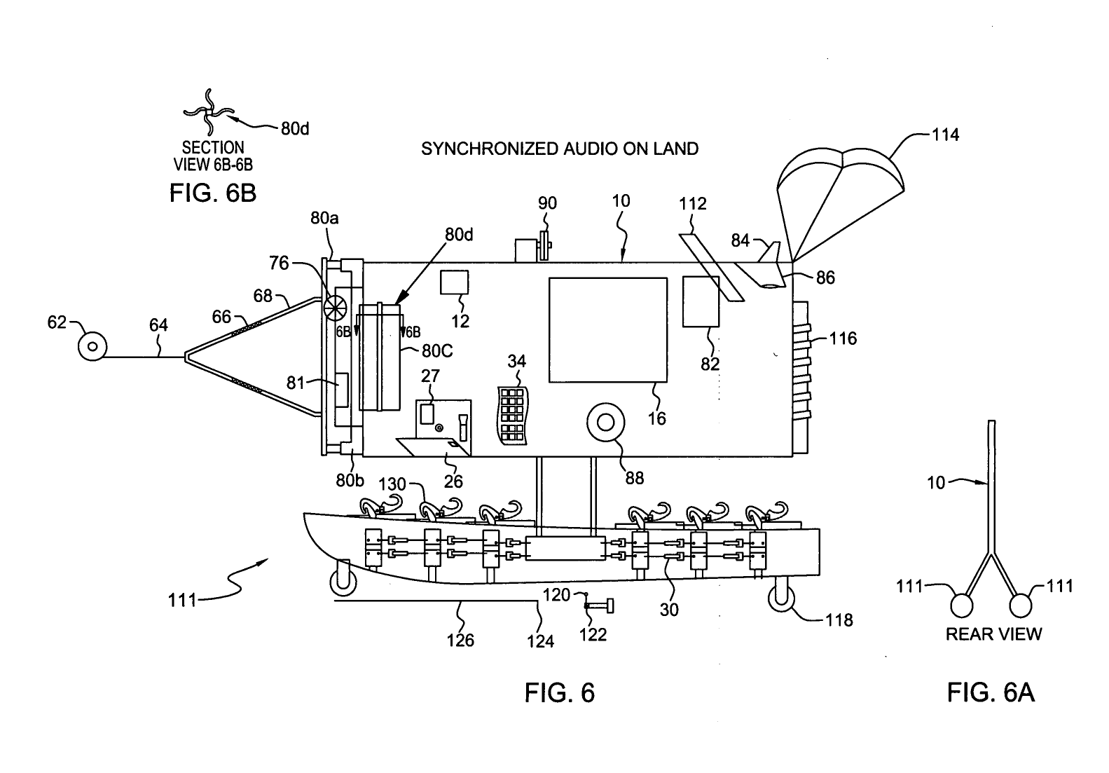

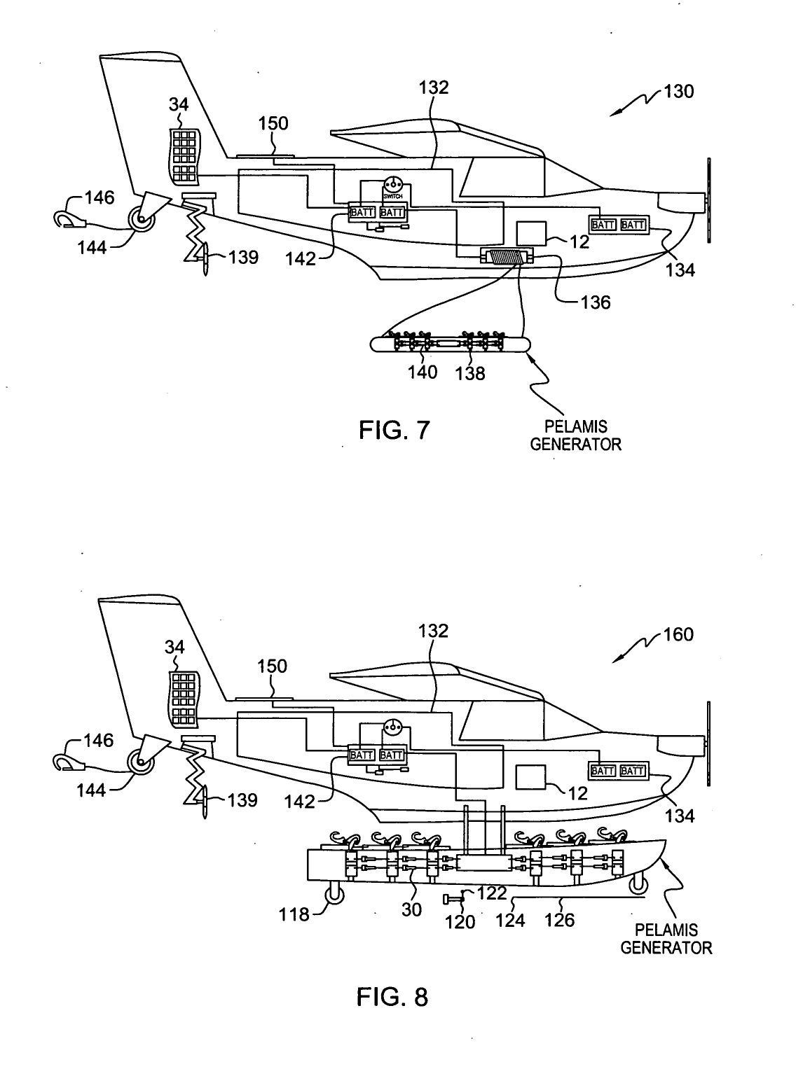

FIG. 6 depicts a synchronized land-towed banner construction 110. Like devices found in the FIG. 3 construction 10, are numbered similarly. The synchronized land-towed banner construction 110 includes a landing gear floats upon which the banner is supported, a retractable airfoil 112, optional rudder, optional parasail 114, optional horizontal stabilizer and lift wing electric igniters for lighting pyrotechnics via remote control 116, a retractable wheel 118, a cotter pin 120, a locking pin 122, a locking pinhole 124, an additional locking rod for latch 126 and a motorized latch 130. Compartment 26 also includes a satnav radio 27. FIG. 6A is a diagrammatic rear view showing a pair of floats 111 below the banner 10 and banner frame. FIG. 7 depicts a plane 130 for towing the banner constructions of the invention. Plane 130 has a sign with audio-visual devices 132, a starting battery 134, a retractable electric spool 136, a flexible joint 138, wind turbine generator 139, a hydraulic piston motor driven generator 140, such as a Pelamis type generator, (for preferable water use when plane 130 is not flying but is floating on water), a dual battery with a/b switch and jumper cables 142, a second retractable electric spool 144 with cable and grappling hook 146 with release. A solar panel 150 and electronic fabric 34 may also generate electricity.

FIG. 8 depicts a plane 160 with a landing gear that is similar to that of FIG. 6.

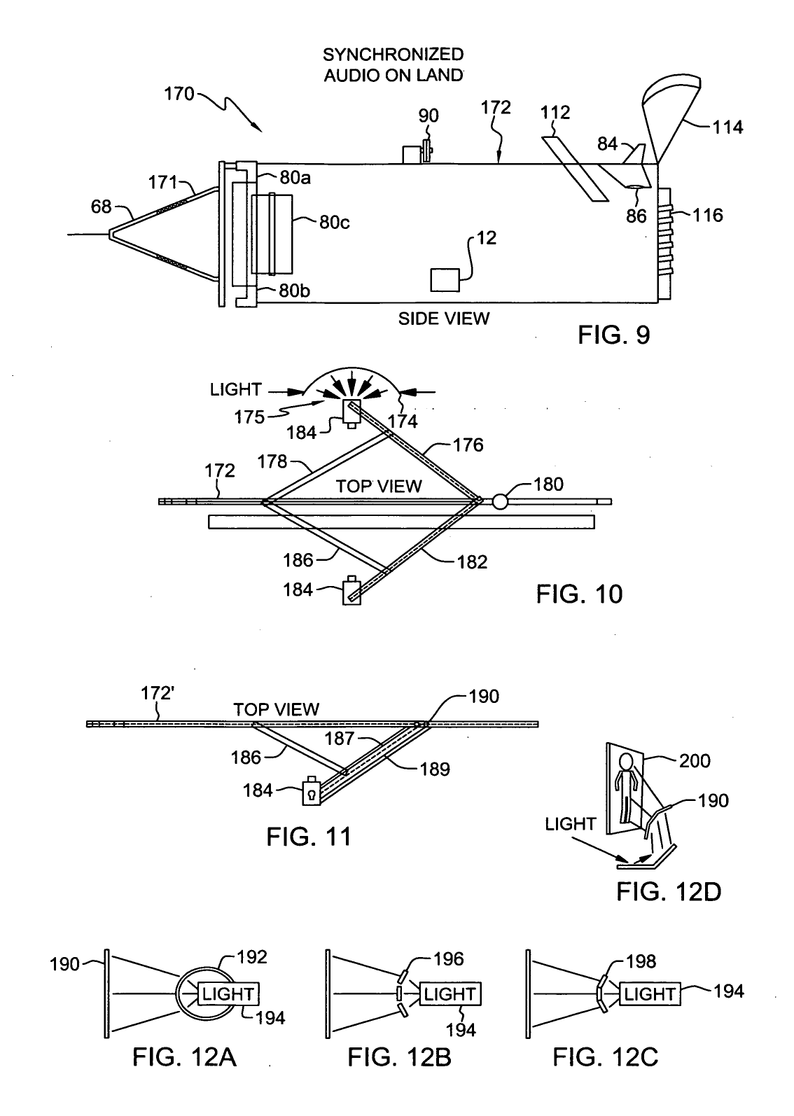

FIG. 9 depicts a simple banner construction 170 comprising banner 172 with optional remote computer controller 12. Banner 172 gets power from a towing plane (not shown) plane or generators (80c). Banner 172 includes battery powered metallic disks 90 that grind together to make sparks, retractable airfoil 112, an optional rudder 84, an optional stabilizer 86, electrical igniters for lighting pyrotechnics vii remote control 116, where the shock absorbers 80a, 80b drive vertical turbine or generator 80c. An electrical conduit 171 is provided in towing bridle 68 to deliver power, for example, from a generator.

FIG. 10 depicts a side view of the FIG. 9 banner construction 172 with LIGHT shining on powering source 175 and arms/braces 176, 178,182, 186 opened by wind pressure or electrically via motor or spring tension/released solenoid 178. Light weight banner in tow with electric projected image with synchronized audio mechanical noise, sound abatement, low-high voltage pyrotechnics, gas welding, grinding sparks, satellite, GPS, transmitter. A wind pressure sensor 180 automatically retracts arm when banner is released from plane to prevent damage to the projector(s) 184. A swing out arm to support projector 184 deploys via remote control or air pressure. The embodiment includes a conventional digital or film projector, or an LCD projector light(s) 184 and an adjustable brace deploys and retracts projector arm 186. In yet another embodiment, the banner can have screen projection elements.

Applicant's banner 172 in tow, includes banners, flags, signs, displays which can be combined with all previous documented information on forward thrust. Besides harnessing conventional power from inside a vehicle and/or other power sources inside an airplane, boat, truck, locomotive, amphibious craft, etc., the present invention primarily uses forward thrust renewable energy from electric generation from wind rotors, iron oxide fabric, piston generators, solar, static electric accumulation generators, etc.

FIG. 11 depicts an alternative embodiment 172′ of the FIG. 10 construction 172, as a top view. The construction 172′ further includes a film projector light lens system 188 (see film in 187 and film out 189), and a motorized roller film feed take up reel 190.

In addition to all previous information on Applicant's banner, an actual high voltage projection image system is mounted on the banner on or within a retractable extendable support arm, anywhere on the arm, preferably towards the furthest end of arm away from banner, which supports a modified electric image projector lens(es) with at least one light to project an image, and a rotatable and/or a stationary track for film to move on and/or guided through or hold in place. The extendable arm for the lens projector can be tubular to protect its inner working mechanisms with rounded elbow hinges that will elongate straight. Tension sensors (for film) are located anywhere on the banner or other display device. Film reels and circuit boards are mounted anywhere on the banner's frame. Electrical wires from a power source and/or remote control of the projection components (such as, for example, lens, reels, arm system, individual power supplies which work off of a battery without electric wires) will allow the reel to communicate with lens system. The end results are film on full reel which travels through or on the extended arm to the lighted lens projection system with automatic focus (lightweight) which shows an enlarged image on the banner screen, and which continues on or within a track (i.e. the same arm) to a receiving reel mounted on the banner frame.

Multiple lenses projection systems 184 will be on one or both sides of banner 172. Modified light lens will be made like ordinary projector lens also, or on a curved contour lens with a retractable hood for each light. Film can curve in a contour on or near contoured bulbs, light, LED, etc., or on a contoured (curved) track projecting image straight down and/or up, according to movement of a hood, which protects and/or blocks any unwanted light. Alteration of a visual image on film (from any kind of projector, either film based, LCD or digital) enhances the image which is projected on the screen of the banner 172. The result is a lens that is close to screen and which will project a tall, wide image. The lens system compensates for any distortion in the image as projected due to the off angle of projection. Three separate film feeds, or three separate stream of streaming video, are projected to form a composite image.

FIG. 11 depicts an alternative embodiment 172′ of the FIG. 10 construction 172, as a top view. The construction 172′ further includes a film projector light lens system 188 (see film in 187 and film out 189), and a motorized roller film feed take up reel 190.

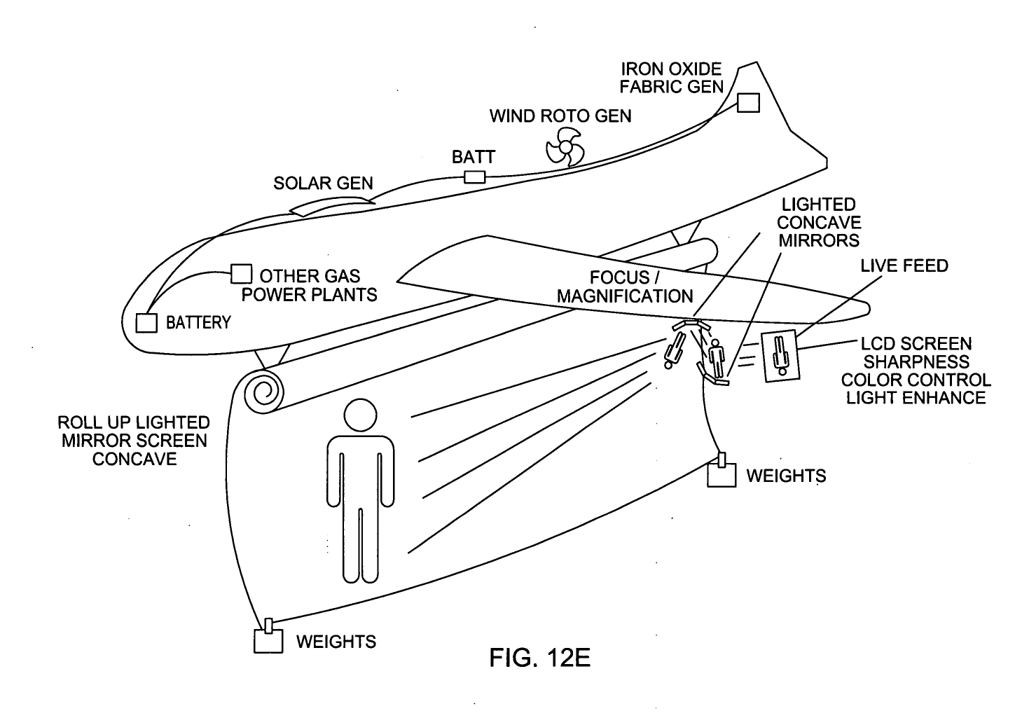

FIG. 12A depicts a banner side with film 190 curved in a track 192 upon which is shone a light 194. FIG. 12B depicts one or more films 196. FIG. 12C depicts the track bent 198 and FIG. 12D depicts the projected image 200 generated by bent film. Another multiple angled lens system works similar as previous when film is fed through extendable arm to project lens and light system, for example: as shown in FIGS. 12A-12D, a wide film has multiple image layers. Each layer can be separated, creased, which angles film. Each angled layer of film can be projected by one light and/or multiple lights for each angle on film or multiple films. Each angle on the film or multiple films is a portion of one image and/or different images. Angled lenses will accommodate the film or films and when lighted, the portion images will become one. The results are a close-up projector projecting images to the screen of the banner. It projects a full image on a tall, wide screen. Other film track arms can become a counter balance another set of arms on an opposite side of the banner, while performing similar duties on the opposite side of the banner. The arms comprising this banner counter balance feature can be artistically disguised to look like animal legs, wings of birds, or wings of an airplane etc. Other generators and motors, with alternate embodiments for electrical streamer images can be employed, as well as optional pyrotechnics displayed in the vicinity of the banner frame.

In yet another embodiment, the invention can use a sunlight magnification reflection, deflection, multiplied alter electrified system. The arm and frame can be unitary. All electric power is given back to its carrier. The screen is hooked up to electric power and preferably comprises an electrically conductive array in a membrane of pixels for an LCD projection.

At least three separate films may be used on: a reel. Filmed footage is divided in parts, such as thirds. Each third is magnified to a desired size. The magnified film is then filmed again. This process then makes that ⅓ image to become a full ex. 8 mm frame. When the ⅓ is thrown, it is the same size as original full image. In this embodiment, multiple mirrors or lightweight reflectors are provided at strategic self-adjusting angles to expand the thrown/deflected, reflected electrified super exposed sunlight. The sunlight will assist daytime protector lights.

The screen has a light detecting ability, along with film image projection. The screen senses light from the projector. Then the membrane or screen retracts darker or two different colors, according to image being projected.

The LCD images can be darkened and then magnified. The LCD also projects in one-thirds, such as, for example, in lens system 9 panels.

While FIGS. 9-12D shown the images projected upon a banner 172, it is contemplated that the underside of an airplane wing can also comprise the banner, as shown in FIG. 12E.

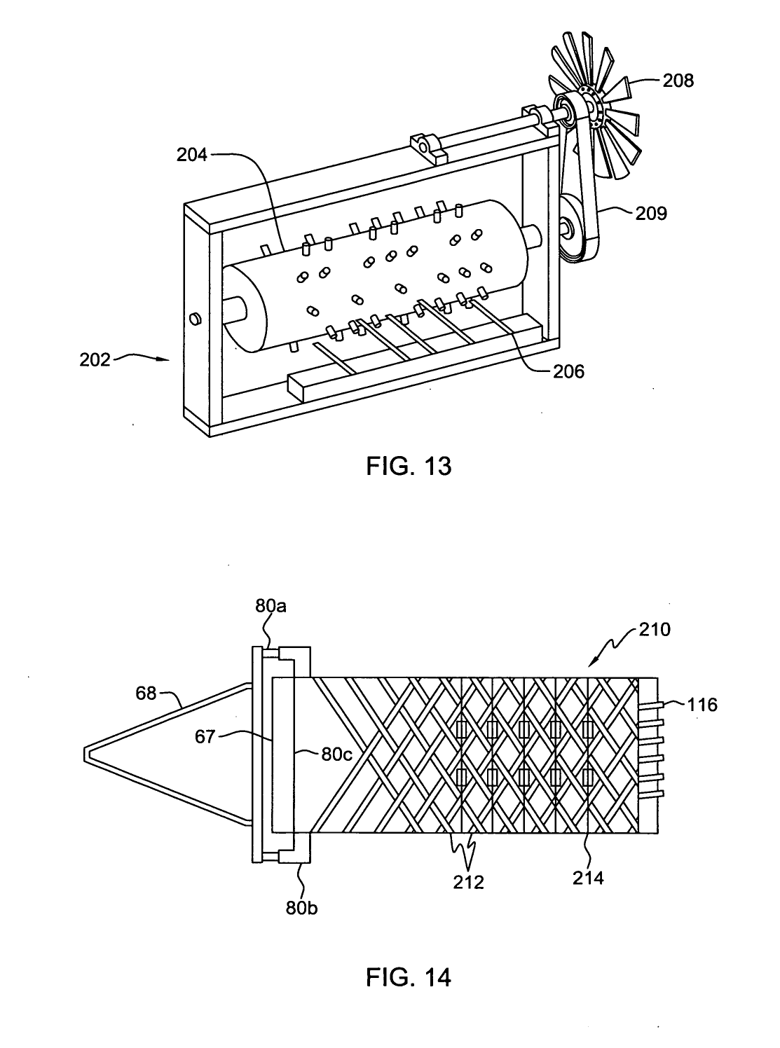

FIG. 13 depicts a wind driven music box 202 that may be mounted on the vehicle, or banner construction, either permanently or in a way that same is removable. Wind driven music box 202 comprises a drum with picks 204, tuned reeds 206 and a wind driven fan or motor 208 with belt drive 209, as shown. The belt drive spins the drum with picks 204. Optionally a computer controller such as controller 12 shown in FIGS. 1 and 3 can control the musical notes.

FIG. 14 depicts a banner construction 210 having interleaved slats 212 to add rigidity and strength, The slats have openings which allow for air to pass through the banner for less resistance to side load. Banner assist rods 214 add rigidity and stability, and also act as a generator to generate electricity and also release air pressure from the banner.

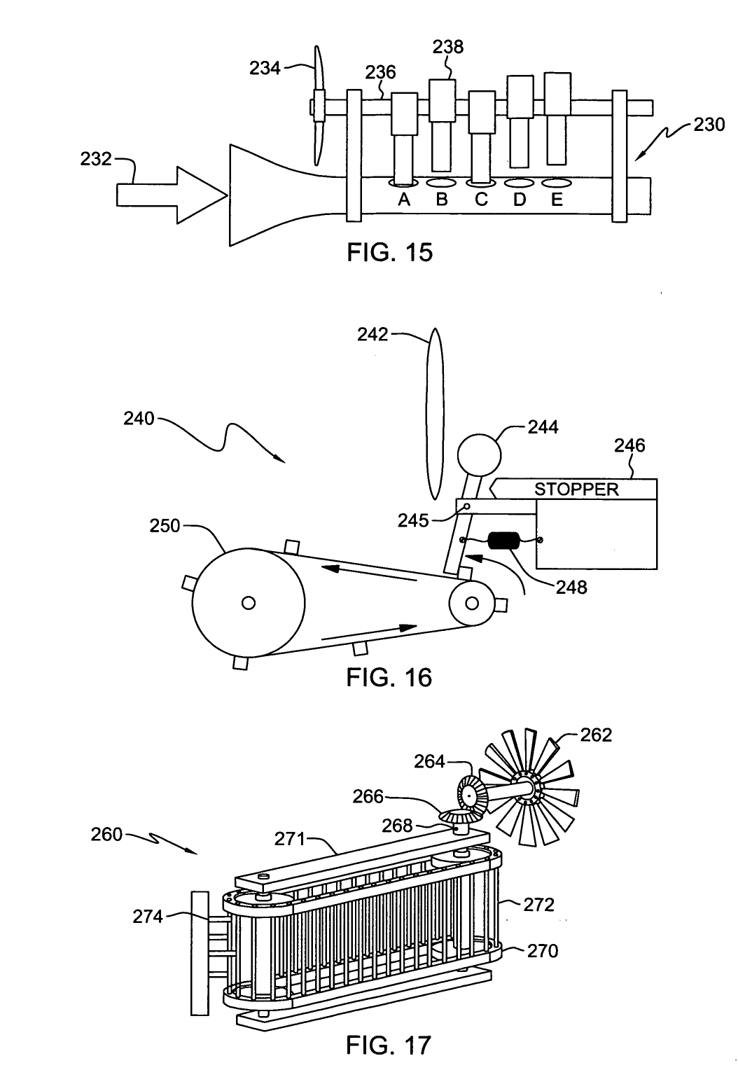

FIG. 15 depicts a wind driven flute 230 that must face in the direction of travel to receive moving air into opening 232. Also, a turbine 234 drives a crankshaft 236 that drives connecting rods 238 to sound musical notes. Alternatively a set of bagpipes (not shown) can also operate on the same principles as wind driven flute 230. Optionally a computer controller such as controller 12 shown in FIGS. 1 and 3 can control the musical notes.

FIG. 16 depicts a gong noise maker 240, which includes a gong 242 that is struck by a mallet 244 levered about pivot 245. A stopper 246 drives the gong in cooperation with a spring 248 and a rotating mechanism 250 and motor driven belt 250. Optionally a computer controller such as controller 12 shown in FIGS. 1 and 3 can control the musical notes.

FIG. 17 depicts a wind driven harp 260. A wind or electric motor driven shaft 262 attached to a bevel gear 264 spins in the wind, driving driven bevel gear 266. Driven bevel gear 266 turns shaft which rotates belt or chain 270 in frame 271. Rotating belt or string 270 moves strings 272 past string picks 274, which sounds notes. Optionally a computer controller such as controller 12 shown in FIGS. 1 and 3 can control the musical notes.

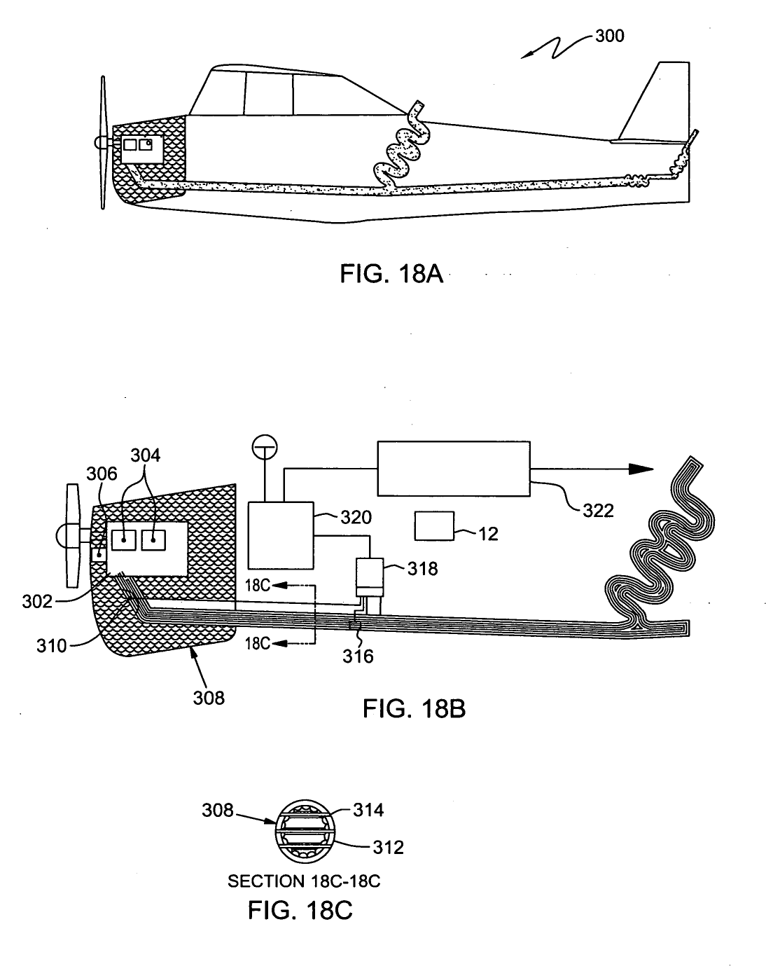

FIG. 18 depicts an airplane 300, the internal workings of which are shown in detail in FIG. 18B. FIG. 18B highlights that in an engine compartment including engine 302, and cylinders 304, foam is removed in a cooling area inlet 306 allowing airflow in. The foam 308 is fire resistant acoustic foam. The plane also includes an enabling air/vac input system 310 for modifying exhaust air flow. A cross section of the air flow piping 312, including angled louver or hinged doors 314 for sound control also is included. An air flow sensor 316 measures engine output due to soot build-up, which triggers an indicator showing a need to replace the muffler system. A transmitter microphone diaphragm 318 is connected to fuse box electrical circuit 320, which manages receiver amplified speaker 322 which can send vibrations or sounds to the banner display of other sound generating device. Optionally a computer controller such as controller 12 shown in FIGS. 1 and 3 can control any visual and/or audio sound displays.

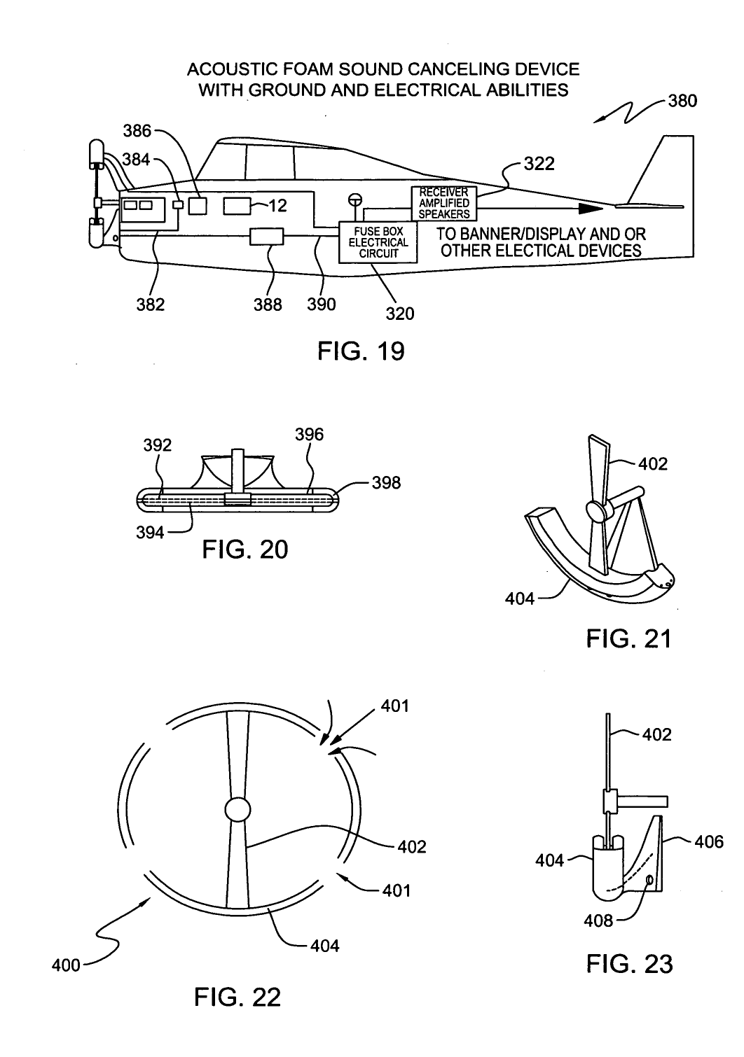

FIG. 19 depicts another plane 380, which has a acoustic foam sound cancelling feature to reduce propeller noise so as not to interfere with any sounds associated with the banner displays. Plane 380 includes a vacuum/blower manifold main line 382 in line with an airflow sensor 384 and a vacuum blower 386. A noise vibration transmitter microphone diaphragm 388 drives is connected to a power cable for deicer metal oxide fibers embedded in foam 390. A fuse box electrical circuit 320 connects to receiver amplified speakers 322, which is directed to banner/display and or other electrical devices.

FIG. 20 depicts the air input part shown in FIG. 19 in more detail. The manifold connects to vacuum 392, which includes sound blower vacuum feed holes. Acoustic foam 396 is depicted around deicer heater wire and metal oxide fibers 398.

FIGS. 21 and 22 depict details of a sound cancelling device 400, where air in let in through air inlets 401 as propeller 402 spins for conventional airplane propulsion in a forward movement. The spinning of the propeller drives noise cancelling speakers in segmented outer ring 404. The sound cancelling ring 400 is segmented with air inlets 401 separating the arcuate segments of the ring 400 to allow the propeller 402 to receive more air.

FIG. 23 depicts a cross sectional view of the sound cancelling device 400, highlighting aerodynamic mounts 406 and optional noise cancelling speaker 408.

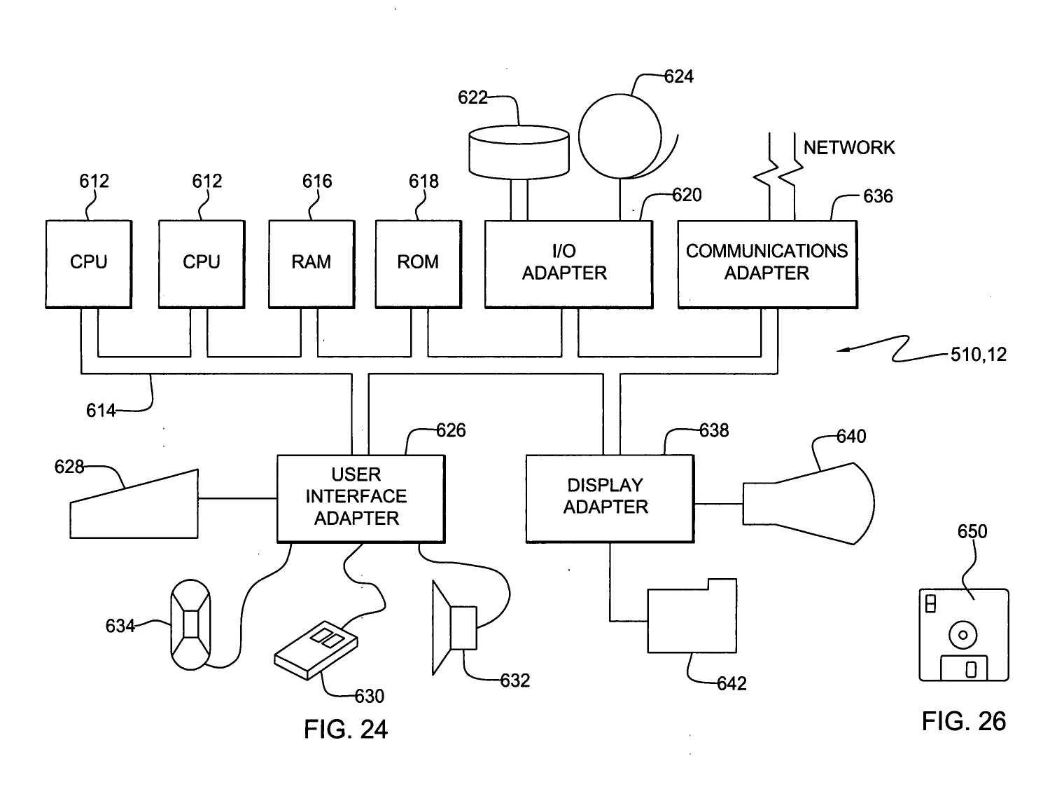

FIG. 24 depicts a system 500 by which server 500 enables command communication with the controller 12 positioned in any of the banner or banner vehicles. Entities can connect to server 510 over the Internet 520 using known communication means. For example, a user with any of a laptop 530 or desktop computer 540 with an operational browser may connect with the server, which operates a program for controlling the various devices and systems described above via controller 12. In addition, any hand-held electronic device 550, including a cell phone 560 or Smartphone may communicate with the server in cooperation with known telephone exchange means. Communication may be wireless and hardwired.

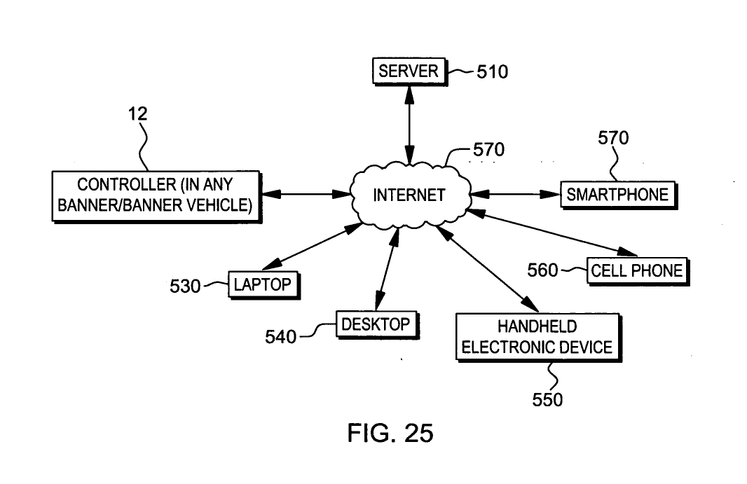

FIG. 25 illustrates a typical hardware configuration of system processor 510, and/or controller 12 in accordance with the invention and which preferably has/have at least one processor or central processing unit (CPU) 612. CPUs 612 are interconnected via a system bus 614 to a random access memory (RAM) 616, read-only memory (ROM) 618, input/output (I/O) adapter 620 (for connecting peripheral devices such as disk units 622 and tape drives 624 to the bus 614), user interface adapter 626 (for connecting a keyboard 628, mouse 630, speaker 632, microphone 634, and/or other user interface device to the bus 614), a communications adapter 636 for connecting an information handling system to a data processing network (either wireline or wireless), the Internet, an Intranet, a personal area network (PAN), etc., and a display adapter 638 for connecting the bus 614 to a display device 640 and/or printer 642 (e.g., a digital printer or the like).

In addition to the hardware/software environment described above, a different aspect of the invention includes a computer-implemented method for performing the above method. As an example, this method may be implemented in the particular environment discussed above. Such a method may be implemented, for example, by operating a computer, as embodied by a digital data processing apparatus, to execute a sequence of machine-readable instructions. These instructions may reside in various types of signal-bearing storage media.

For example, the invention might comprise a 9.A computer system and method of displaying a series of discrete advertising displays to different sets of viewing responders at a plurality of viewing locations. The method executes steps of providing a computer system for implementing an advertising selection and display process for public responder viewing; a database for receiving and storing data; said database having data processing systems and a microprocessor by which a firm provides said advertising selection and display process; an advertiser into a conditional contract with a user capable of supplying at least one first unit of advertising display to a first targeted audience located at a targeting location; said user identifying and establishing an electronic data base of a defined population which would respond to said first advertising display; said user using a local area network or the internet to display said first advertising upon a towed banner having at least one generator responsive to forward movement of said towed banner; said user using said local area network, internet and other media to create said first advertising display to be viewed by responders at said first targeted location; finalizing said first advertising display and transferring said first advertising display remotely to said towed banner; said user using said microprocessor in creating said first advertising display and in determining said first targeted location of responders viewing of said display; said user repeating steps “a” through “I” herein to determine subsequent further advertising displays to further responders at subsequent further targeted locations; said user proceeding to remotely and incrementally display said first advertising display upon said towed banner at said first targeted location until display of a further advertising display at a subsequent further targeted location and said further display is remotely displayed upon said towed banner at said subsequent further targeted location; and, said user using said microprocessor to account for and to collect revenues through respective individualized prices to account for creating said display and to carry out said display of all said displays at all said targeted locations within a predetermined period of billing time.

To operate the invention, the user connects to the server 510, which operates an application that presents the user's browser with images through a graphical user interface that the user just clicks on to activate and otherwise control the various devices and systems shown above, where necessary.

Thus, these aspects of the present invention is directed to a programmed product, comprising signal-bearing storage media tangibly embodying a program of machine-readable instructions executable by a digital data processor incorporating the CPU 612 and hardware above, to perform the method of the invention.

This signal-bearing storage media may include, for example, a RAM contained within the CPU 612, as represented by the fast-access storage for example. Alternatively, the instructions may be contained in another signal-bearing storage media, such as a magnetic data storage diskette 650 (FIG. 26), directly or indirectly accessible by the CPU 612.

Whether contained in the diskette 350, or some other computer readable medium, the processor/server 510 comprising CPU 612, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape). Other suitable signal-bearing media include memory devices in transmission media and instructions stored in formats such as digital and analog and memory devices in communication links and wireless. In an illustrative embodiment of the invention, the machine-readable instructions may comprise software object code. It should also be obvious to one of ordinary skill in the art that the technique of the present invention could be implemented on a network in a variety of configurations.

Hence, the invention includes a computer program product including a processor and a set of processor readable instructions that when executed by the processor execute a method for controlling the banner mounted devices and systems.

In a waterborne version, the banner and/or frame is carried by a floating vessel such as a boat. It can also have a forward velocity wind generator. But it can also have a “Pelamis”-type wave generator of underwater waves. It works on waves of all kinds, besides the conductive fabric can always tear with flying debris during heavy wind. The Pelamis system is preferred for waterborne embodiments, because it will be self sufficient in water, air and land. All the other embodiments are for technology with forward thrust velocity.

Also, the banner displays and advertisement can have auxiliary-colored liquids for simulated Halloween scenes and real cotton characters and cloud and snowy Christmas sceneries, real puppets and toys on display with real mechanical sound, etc.

The generator can power miniature hydraulic piston pump, micro pumps|centrifugal pumps|diaphragm pumps|vacuum pumps and hydraulic pumps to augment the displays. These can include custom mini and micro piston pumps of Diener Precision Pumps Hydraulic Cylinder, Hydraulic Pump, Hydraulic Motor, Hydraulic, powered by mini hydraulic power packs—AC, DC, reversible and uni-directional, with or without HydroControl. Gear pumps, hydraulic control valves and electronics may be provided. Hydromatic Piston Miniature Piston Pump measures 44×17.3×25.5 mm. The Clark New Miniature Piston Pump Great Solution for Low Volume Applications can be used. Piston Pumps can optimize hydraulic fan drive systems. Hydro Leduc, miniature hydraulic motor, miniature hydraulic motors, miniature hydraulic motor may be used. Radial piston pumps (fixed displacement) are used especially for high pressure and relatively small flows. Another pump is one known as EXPO21XX for hydraulic axial, radial piston pumps and a combination pumps. These axial piston micro-pumps typically used for oil exploration have an operating pressure of up to 350 bar, displacement of 0.075 cm /rev., temperature of up to 175 C in a Mini Air Driven Hydraulic Pump Unit. A large piston drives a smaller hydraulic piston, which provides flow at high Tentec Mini Air Driven Pump Tentec Air Driven Pump Units, which operate on the miniature hydraulic piston pump

In a further alternative embodiment, the banner can be designed such that with the force of the aircraft or vehicle towing, that the man made vibration and acoustics on the frame will assist or create a longitudinal and/or transverse wave, which will assist the hydraulic generator, with or without the wind.

In the forward velocity generator version, the banner depends on the wind to move the electrically conductive frame, which preferably has a hinged connection to form a rectangle or square shape. Within the frame is the advertisement or display connected to the frame with a series of ball joints (6 inches of play) so as the frame moves and waves the inners parts are not affected by the wind. Conventional flags and banners are known to have a single arm, stick or pole through which the banner is applied, which hinders viewing of the logo or other visual display because its entire surface is constantly moving in the wind. This also applies to signboards. In a further embodiment, the banner is provided with a flexible surface, wherein the generator generates electric power for powering the visual and audio effects which occur while the banner is towed.

Therefore, the forward velocity air intake generator does not require ambient weather provided wind. In contrast, air is pulled into an intake of the Venturi generator, then it increases its force and then forces it against a series or fixed torqued rotors to generate electricity to power the visual and audio displays of the banner.

The difference of the present invention is that an air, water or land vehicle's forward thrust is used to power-up the generator. The auxiliary rechargeable battery does not normally fail and if it does fail, the power source will continue to generate as long as there is forward thrust, producing its own wind or waves.

To keep the banner frame generally flat while moving, besides its aerodynamic design and leading edge, there may be stabilizers and rudders.

While the aforesaid describes digital animations and audio sound emanating from a conductive surface of a flexible towed banner associated with a forward velocity generator as alternate embodiments, the present invention also relates to advertisements and attracting one's attention with animation and sound mechanically produced on a frame for a banner, flag, billboard or sign, which is towed, pulled, and mounted to a vehicle, such as an airplane, car, motorbike, boat. Forward movement of these vehicles in motion cause a thrust or further forward motion of the vehicle to create wind energy from the velocity of the forward moving vehicle, which can spin fans (blades) in a housing, or which can rub against an object, such as a stick, made of any material. These alternative embodiments make mechanical visual effects, as well as noise or sound. This can also be accomplished with an unstabilized wand or flat stick, broad or rounded object ex. (ruler shaped) on a movable, slide along frame or a secure mount. The instability, flicker, wobble mechanical motions will make noise or sound by hitting of other objects.

Another mechanically based noisemaker is a chamber housing with optional air inlet holes, which can make the noise (sound of horns, whistles, familiar tones of sounds). Inlet holes can guide air from the towing of the banner through to a point associated with the banner where it meets thin fin(s) of films, plastic which makes whistling noise fin(s) can angle for different tones, pitch frequencies. Entire waving banner or flag, billboard, etc. . . . can be noisemaker of sound.

For example, in this alternate embodiment of mechanically produced animations and sounds, the waving of flag or banner can have a frame or part of attached frame, with gongs and/or wind chimes that hit off each other and/or mallet(s) or striker, single, double-sided, several-sided, made of rubber, plastic, cloth, fabric, metal, etc. Also part of banner, flag with natural waving of banner, mallet will make contact with gongs, wind chimes, Jingle Bells, rattle, etc. Entire banner waving can also activate jingle bells or a tambourine-like design. These features can also be at tail with another noisemaker at leading edge. Unstable elements can be mechanically moved by the forward thrust of the moving vehicle, such as a baby's rattle, can flicker, wobble, making noise. Hollow tubes, wind chimes, tambourine features, gongs, steel drums, etc., can drape from or otherwise be attached to the frame of the entire banner or a portion of the banner. Moving parts can strum guitar strings, hit steel drums, play violins, fiddles, strum harps, blow trumpets and mimic other well known instruments. These mechanical visual features of the alternate embodiment, with or without electrically produced sound, can be augmented by wind driven grinders for a continuous visual presentation of colorful or single sparks of a controlled lighting display.

Electric grinders can be individual or provided in series or parallel, being driven from the same or multiple power sources. An example of a grinder consists of a housing, power source, male and/or female counterpart, tension springs, flint and/or any common alloy, stones, granite metals, gun powder, etc., which are loosely or tightly packed. Grinders can simulate sparks and/or flames with combustible additives, time and color delayed layers, such as chalk, pencil lead, dirt, clay, mud, other common alloys. The grinder can make logos and/or messages or other images, such as logos and messages not limited to grinders. Printed symbols, noisemakers can combine with floats, balloons, kites, handheld or secure firmly to ground or poster base.

To keep the banner stable when towed into the wind, stabilizer(s) can be mounted and/or preexist anywhere on the towed banner or billboard. They can stabilize and/or create lift, reduce drag.

Wave movement anywhere of the banner can create sound, noise, turning of gears, pulling, pushing, zigzag, sliding and turning motion, etc to produce visual animations of representative things, characters, people, places, etc.

Gears can control the regenerative power source by allowing faster and/or slower motion, therefore allowing a turntable to play prerecorded messages, music, from a disc, CD vinyl record, etc. Although with a Faraday invention, the wind driven energy and associated coil can activate and create images and sound with lights, speakers, amplifiers, sound enhancers, bullhorns.

Solar panel cells can create energy to use at the same time with wind energy and/or they can store their energy to be used later. An echo sound deflector can also spread noise (sound).

All parts can be aerodynamically designed with center of gravity that can or cannot collaborate with other parts.

Global Positioning can be used to determine the appropriate images or sounds to be conveyed for a pre-defined audience.

The power source can supplement a conventional electrical source inside the vehicle, such as an airplane, cars, etc., solely and/or working along with wind and solar.

Wheel or turbine-shaped noisemaker can be provided with a mount for cars. Different sizes can be provided for the noisemakers.

Fans and adjustable gears can play music boxes, provide sound with automatic music player devices, etc., attached to the frame of the banner.

Adjustable or moveable noisemaker or mallets can move controllably stable or freely unstable on rack.

Sound from noisemakers can enhance airplane engine sound emission in a humorous, good way.

Reflectors and delay grinders can have timers and/or spring triggered mechanisms to determine altitude or speed of the vehicle.

To attach the banner, a tow cable and car mount is part of and/or one whole banner, attached to an optional frame for the banner.

The noise producing and animation producing banners can be made of any common material and/or alloy, which has electrically conductive members, such as fibers embedded within a base material for the banner , such as foam, rubber, textile, aluminum, plastic, etc.

Whirligigs can be added onto factory or place of business, which most signs that require permits or approval, zoning, etc. The present invention can also apply to traffic signs that are state, county or private or township owned.

The mechanical images can be whirligigs, which can have any types of gear systems, lights, etc. to produce visual images associated with the towed banner.

Banners can also have digital animations and lighted neon sign images.

Alternatively, wind or wave powered turbines can be built into a frame for the banner, with double reinforcement with spring or piston shock absorbers to allow for shifting and taking in a load of heavy and fast storm wind. Therefore, if the banner is damaged and/or fails, the mechanical sound or animation producing portion such as the whirligig can be salvaged and recycled into another sign/billboard.

Alternatively images associated with the banner can include visual sparks or other images caused by conventional means such as flares. Water, and oxygen gas can be harnessed from air, atmosphere or can be fed from tanks stored in the towing vehicle, including torches such as acetylene torches.

Alternatively, plasma welder devices can create sparks by cutting or melting metal substrates. This also applies to other welding devices, such as mig and tig and other applications of welding trade in the method of creating sparks associated with the towed banner.

The towed vehicles regenerative power can also illuminate other visual effects, such as rotating disco balls and strobe lights.

In an alternate embodiment of the towed flying or pulled banners, flags and signs of the present invention, a Tesla coil (mini or large) can be added for more visual effect being supplied by already charged/uncharged batteries ranging from low volts to high volts. For example, a larger plasma lightning bolt can travel and fork anywhere associated with the towed banner, sign, billboard, or flag. Turbine rotation of materials such as PVC, vinyl, etc., against other materials, such as rubber, fur, hair, polyester, etc., can create static electricity which builds up in the leaden jar (capacitor). This activity creates a very visible spark when capacitor is discharged. Chemical energy can produce visual effects, such as flares, any pyrotechnic composition liquid or solid pyrophic substance, and/or liquid or solid highly flammable substance. Disco balls, strobe light, neon lights can also be visual. Oxygen and other gases and/or liquid can be harnessed from air, atmosphere and/or supplied from tanks associated with the towing vehicles. As mentioned previously, animated whirligigs, wind, solar, electric, etc., can be built on and/or into highway (road) signs, billboards, store front/place of business signs that require state, governmental, counties, private township, municipal Highway Department requires approval, permits, zoning, etc.

Whirligigs can be constructed with at least one or more double reinforced frame connected or riveted together. The frame and whirling animation can alternatively have springs and/or pistons with a pivoting ability to hold in place or withstand, timed movement provided by storms or hurricane force winds. If the sign or billboard fails, the whirligigs can be salvaged and be revised and/or remounted on other banner frames.

In addition to mechanically or electrically produced noise, music, sound grinding sparks, a Tesla Coil (mini or large) can be added for more visual effects being supplied by previously charged/uncharged batteries, ranging from high volts to low volts. For example, a dead battery being charged by a wind turbine/solar generator can create a spark to a larger plasma lightening bolt that can travel and fork or discharge anywhere on the respective frame of the banner/signs/billboards/etc. It can have an auxiliary power supply from a vehicle. More visual effects can be supplied with many welding techniques or trade practices (example: a plasma torch tip can be activated, or charged, with wind and electric/batteries as mentioned and a compressor to supply compressed air/gases (example: oxygen, hydrogen, helium, etc.) to a plasma torch. The charged plasma torch associated with the banner frame can also burn metals, alloys, synthetic/natural materials, etc., making visual effects. Other welding techniques, known to the trade such as mig/tig, can produce same effect being supplied from turbines or from planes acetylene, hydrogen, helium, oxygen, etc.

Other visual effects can be from a red hot heated coil being hit with droplets of water (or other liquid substances) to crate large long forking sparks. The coil will be made of carbon steel or other minerals or alloys. Other visuals can include an exothermic cutting torch, oxyfuel welding. Electric blue sparks, no batteries or electrical required, although could work along with other supplied electric. Turbine rotation of PVC, vinyl, etc, against rubber bands/fur/polyester/etc., can crate static electricity which builds up in the Leyden jar (capacitor). This creates a very visible spark when capacitor is discharged. Chemical energy, such as flares/any pyrotechnic composition, liquid or solid, pyrophic substances and/or liquid or solid highly flammable substances.

Disco balls, strobe lights, neon lights can also serve as visuals. Oxygen and/or other gases or liquids can be harnessed from the air or atmosphere, or can be supplied by the vehicle (airplane, car, etc.) Animated whirligigs are on banners, signs, billboards, etc. These animated whirligigs, wind or solar electric supplied, can also be built on and/or into highway or road signs, billboards, storefronts/place of business signs that required state or governmental, counties, private townships, municipal Highway Department, or congressional approval permits, zoning, etc.

The built-in whirligigs have at least one or more double-reinforced frame(s) riveted or otherwise connected together. The frame and animation can have springs and/or pistons with pivoting ability to hold and withstand time and maximum movement against storms and hurricane-forced winds. If sign or billboard fails, the whirligigs can be salvaged, reused or remounted on other signs/billboards. As turbine assist gears and gears assist animation, additional movement to same and/or other animation is accomplished with a turning shaft and strings, for example a ventriloquist puppets on strings.

As a further alternative embodiment, collapsible animations are partially collapsible. Whereas mechanical and base support and the mechanically moving parts are uncollapsible, everything else around it can be collapsible. For example, a bird body is made out pieces of hollow plastic tube connected thru or individually by a collapsible string and the mechanics of turbine, base, shafts, and cones. The moving wing of bird does not collapse. Although extended and/or individual parts of mechanical components are collapsible, the collapsible parts are securely attached to main frame string, so when wind picks up and the banner deploys, it tightens the main string, therefore lifting body of bird.

Although entire flag assembly can be collapsible with a series of string, tube, hardware, knots on string (fasteners), when flag deploys, it will lift animation into working position. This example of additional movement to an animation main gear and cam, makes a motion of a simulated baseball batter turning into a pitch and another cam working off main gear, flicks the batter's wrist and feed the ball with chain and/or strings continuously. Distance and timing of gears and/or strings will animate pitches to be hit or missed.

When the banner is affixed to a vehicle side, such as a truck, the forward velocity generator can power tool chargers or an emergency flashlight, a power source to charge a user's cell phone in case the cigarette lighter fuse has blown, an outlet/cigarette lighter plug to plug in 12v power tools, such as grinders with a diamond blade, to cut bricks, because a customer's electric outlet circuit has popped and no one is at home to flip the switch back on in the fuse (breaker)box. The generator can also recharge cordless tool battery packs. The banner, when affixed to a truck side, can provide a visible place on user's truck to advertise user's company name, phone number and recorded messages of what the user offers and visible video/dvd/disc footage of work completed and or quality installation procedures with speakers, music, noise etc., which may be mechanical (ex. a mallet striking a gong) and or electric (including digital images or analog images, such as whirligigs), etc.

A water proof frame door is kept under lock and keys for the user to physically retrieve a continuous fully charged/charging flash light that the user can carry anywhere on customer's property, either on a mounted/magnet on a side, front, top, back, under or tow behind user's truck. When the truck is parked, it can use stored energy previously stored from accumulating the vehicle's forward thrust (pulling power) and electric generation from wind, solar, Pelamis-type wave generator, electronic fabric, power source from vehicle etc. This obviates the need for gas generators which are difficult to transport, are noisy and gas is expensive. Also, the conventional fuel container and gas generator take up too much room in the user's truck and there is the disadvantage of a gas spill all over a customer's lawn, driveway, etc, or if the user forgets or loses the gas container then the conventional gas generator is useless. Therefore, Applicant's invention overcomes the aforesaid disadvantages.

Another major difference in Applicant's towed moving banner and generator is that the audio, noise, sound, speakers, microphone, etc., can be provided in multiple, related displays. For instance, a flying banner over a stadium can be thematically coordinated with a sign mounted/towed on a truck over a bridge or on track of Indy 500 car racing event or display can be pulled on/behind a boat in water along a seashore. Part of the animations or images can be on the flying banner is in the air and part can be towed by a vehicle on the ground, and if a water course is available, animation/images and sound can be produced on a banner that is being pulled by boat is either on the water or in the air, such as by a parasail. Part can be in the air, on the ground or in the water, such as at a Great Adventures Air Show, or on loud speaker at a car race or stationary on a beach shore and/or audio/speakers/microphone on a moving vehicle on shore, with pre recorded messages and/or live narrator via radio frequency, transmitter, receiver, satellite etc.

An alternative embodiment can be a survival box which can have a camouflaged banner in a container disguised as a shape, such as a botanical shape, disguised as a tree, plant. Power supplies can be powered by wind, rotary energy, electric energy, fabric, solar, etc. when dropped remotely. The survival box becomes a self-sustaining transmitter/receiver, audio, sensors, visual effects, etc. for the banner transmitting images therefrom.

In another embodiment, a banner can display images when powered by a A rope generator capturing up and down movement of the boat as it is tied by a rope to a dock or is anchored out at sea. This generator uses a dock rope or an anchor cable in part or whole with boat when boat when the boat is tied to a pillar of a dock. Movement of the boat on water will activate a piston generator or a tension spring generator, etc. An anchor on an air boat, boat, amphibious can also house a generator, and which has an attachment or is part of the whole craft with retractability to become mobile and can be deployed anywhere, without being touched or having to be dismantled. The banner portion is flexible and electrically conductive to display images.

An air towed banner can be released like conventional banner with a tow hitch or other attachment.

One or more helium-injected canopy balloons can assist in the air buoyancy of a banner or sign, whereby floating of the banner exposes it to air movement for activating any generators of the banner frame of the floating banner.

Pre-typed words, or type your own words, phrases, send and receive from cell phone, keyboard can be remotely sent to the banner by the systems of FIGS. 23-25.

Although examples of the invention have been shown and described, it would be appreciated by those skilled in the art that changes may be made in these embodiments without departing from the principles and spirit of the invention, the scope of which is defined in the following claims and their equivalents.

1. A moving vehicle based energy-efficient banner system, comprising:
a moving vehicle; and
a banner structure associated with the moving vehicle configured for securing and maintaining attention of responders in a vicinity of the moving vehicle and banner structure and for deriving electrical and mechanical energy to facilitate said securing and maintaining by capturing natural wind and sunlight, or airflow or water flow available by movement of the moving vehicle, the banner structure comprising:
a controller;
a water- or wind-driven turbine for generating electrical current;
an electrical current storage device; and
a display device connected to the controller for displaying visual content for delivery to responders.

2. The moving vehicle based energy-efficient banner system as set forth in claim 1, further comprising a sound system for generating and delivering audio content for delivery to the responders.

3. The moving vehicle based energy-efficient banner system as set forth in claim 2, wherein the sound system is at a fixed location proximate the responders and wherein the audio content is controlled and synchronized by said controller with delivery of said visual content on said display device.

4. The moving vehicle based energy-efficient banner system as set forth in claim 1, wherein the moving vehicle is one of the group consisting of a truck, a car, a boat, an airplane, a kite, a glider, a personal vehicle, a golf cart, a personal water craft, a warm-up vehicle and a motorcycle.

5. The moving vehicle based energy-efficient banner system as set forth in claim 1, wherein the banner structure is towed by the moving vehicle.

6. The moving vehicle based energy-efficient banner system as set forth in claim 1, further comprising a GPS, whereby the visual and audio content is delivered as a function of banner geographic location.

7. The moving vehicle based energy-efficient banner system as set forth in claim 1, wherein the wind- or water-driven generators are constructed to operate under Venturi principles.

8. The moving vehicle based energy-efficient banner system as set forth in claim 1, further comprising a means for generating electrical current in the group consisting of a solar cell, a hydraulic motor driven generator, a wheel contacting roller generator, a braking mechanism thermal driven generator and electricity generating shock absorbers associated with the vehicle wheels.

9. The moving vehicle based energy-efficient banner system as set forth in claim 8, wherein the generators are interchangeable.

10. The moving vehicle based energy-efficient banner system as set forth in claim 1, further comprising a high voltage projection image system disposed within a retractable extendable support arm.

11. The moving vehicle based energy-efficient banner system as set forth in claim 10, wherein the image system comprises a image projector lens with at least one light to project an image, a rotatable or stationary track where the image content is derived from film and multiple lenses where the image content is digital.

12. The moving vehicle based energy-efficient banner system as set forth in claim 10, wherein the extendable arm for the lens projector is tubular to protect its inner working mechanisms with rounded elbow hinges that will elongate straight, angled or curved.

13. A vehicle based energy-efficient banner system, comprising:
a vehicle; and
a banner structure associated with the vehicle, said banner structure configured for securing and maintaining attention of responders in a vicinity of the vehicle and banner structure;
said vehicle having an electrical current power supply communicating with said banner structure; and said banner structure deriving electrical energy from said vehicle's electrical current power supply to facilitate display of visual content to the responders, the banner structure further comprising:
at least one high voltage projection image system disposed within at least one retractable extendable support arm for displaying visual content for delivery to the responders.

14. The vehicle based energy-efficient banner system as in claim 13, further comprising
said vehicle being a moving vehicle; and
said banner structure associated with the moving vehicle configured for securing and maintaining attention of responders in a vicinity of the moving vehicle and banner structure and for deriving electrical and mechanical energy to facilitate said securing and maintaining by capturing natural wind and sunlight, or airflow or water flow available by movement of the moving vehicle and the banner structure.

15. The vehicle based energy-efficient banner system as set forth in claim 13, wherein the image system comprises an image projector lens with at least one light to project an image.

16. The vehicle based energy-efficient banner system as set forth in claim 13, further comprising a sound system for generating and delivering audio content for delivery to the responders.

17. The vehicle based energy-efficient banner system as set forth in claim 16, wherein the sound system is at a fixed location proximate the responders and wherein the audio content is controlled and synchronized by said controller with delivery of said visual content on said display device.

18. The vehicle based energy-efficient banner system as set forth in claim 13, further comprising a GPS, whereby the visual and audio content is delivered as a function of banner geographic location.

19. The vehicle based energy-efficient banner system as set forth in claim 13, further comprising a means for generating electrical current in the group consisting of a Venturi generator, a bladeless generator, DC electrical storage device, a solar cell, a hydraulic motor driven generator, a wheel contacting roller generator, a braking mechanism thermal driven generator and electricity generating shock absorbers associated with the vehicle wheels.

20. The vehicle based energy-efficient banner system as set forth in claim 19, wherein the generators are interchangeable.

21. A method for displaying a series of discrete advertising displays to viewing responders at a plurality of viewing locations using a moving vehicle, comprising the steps of:
a) utilizing forward-thrust driven electrical generators and the forward movement of the moving vehicle to create an electrical power supply;
b) receiving and memory-storing audio and visual advertising content for public responder viewing;
a database for receiving and storing data;
c) delivering the stored audio and visual content to said viewing responders using any of an electrical visual display device and electrical audio delivery device and both, wherein said devices are electrically powered by the electrical power supply; and
d) controlling said display remotely.

22. The method for displaying as set forth in claim 21, wherein said received audio and visual memory-stored advertising content is downloaded directly, using near-field communication means or via the Internet.

23. The method for displaying as set forth in claim 21, wherein said memory comprises a database.

24. The method for displaying as set forth in claim 21, wherein said received audio and visual memory-stored advertising content is downloaded is provided by an advertiser

25. The method for displaying as set forth in claim 21, wherein said received audio and visual memory-stored advertising content is delivered as a function of GPS-received coordinates.

26. The method for displaying as set forth in claim 21, wherein said received audio and visual memory-stored advertising content is delivered via a towed banner.
